(19) United States
(12) Patent Application Publication
(10) Pub. No.: US 2013/0132382 A1
(43) Pub. Date: May 23, 2013

(54) END CREDITS IDENTIFICATION FOR MEDIA ITEM

(71) Applicants: Vsevolod Kuznetsov, Sankt-Petersburg (RU); Andrey N. Nikankin, Sankt-Petersburg (RU)

(72) Inventors: Vsevolod Kuznetsov, Sankt-Petersburg (RU); Andrey N. Nikankin, Sankt-Petersburg (RU)

(73) Assignee: RAWLLIN INTERNATIONAL INC., Tortola (VI)

(21) Appl. No.: 13/302,945

(22) Filed: Nov. 22, 2011

(51) Int. Cl. G06F 17/30

(52) U.S. Cl. 707/736; 707/E17.101; 707/E17.009

(57) ABSTRACT

Systems and methods for automatically identifying end credits in a media item are disclosed. An analysis component analyzes a media item and identifies a transition point in the media item where end credits begin and a presentation component presents a prompt, such as a survey, based on the transition point. In another aspect, a monitoring component monitors at least one of content or audio of the media item. According to this aspect, the analysis component analyzes the at least one of the content or the audio, identifies a pattern of the media item associated with the end credits, and identifies the transition point as a function of the pattern. In various aspects, the pattern is associated with a streaming of text, a music soundtrack, an absence of speech, an absence object movement, or an absence of an appearance of objects included in the body of the media item.

### TECHNICAL FIELD

This application generally relates to automatically identifying ending credits of media items and events associated with the identifying.

### BACKGROUND

Multimedia such as video in the form of clips, movies, and television is becoming widely accessible and to users. For example, the world wide web has opened the dimensions of video as both open data and licensed data. In addition, as video is accessed from a centralized recourse over a network such as the world wide, the playing of the video can be monitored over the network. In turn, additional content can be provided to a viewer of the video over the network in an individualized manner. In other words, additional content in association with a video can be provided to a user as a function of the manner of consumption of the video and the user itself

For illustration, when a user views a video program, a content provider may desire to offer the user an opportunity to rate the film. However, launching a request too early may be considered by a user as poor usability feature, plus user may not form an opinion to that point. Accordingly, the timing and placement of prompts or pop-ups in a video can greatly affect the effectiveness of the prompt or pop-up. Nevertheless, traditional methods of realizing such feature require an engineer to manually place a tag in the media item where the engineer assumes is a good place to insert a prompt. Then a media player retrieves the value of that tag and uses it to launch an associated popup message. However, this method is not ideal as it requires expensive human resources and prone is to human error.

The above-described deficiencies associated with providing prompts associated with video content are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with automatically identifying end credits of a media item and acting upon the identifying by providing a prompt. For instance, an embodiment includes a system comprising a memory having computer executable components stored thereon, and a processor communicatively coupled to the memory, the processor configured to facilitate execution of the computer executable components, the computer executable components, comprising: an analysis component configured to analyze a media item and identify a transition point in the media item where end credits begin; and a presentation component configured to present a prompt based on the transition point. In various aspects, the prompt can include but is not limited to, a survey about the media item, an advertisement, or a link to content associated with the media item.

The above system can further comprise a monitoring component configured to monitor at least one of content or audio of the media item, wherein the analysis component is configured to analyze the at least one of the content or the audio and identify a pattern of the media item associated with the end credits, and wherein the analysis component is configured to identify the transition point as a function of the pattern. In various aspects, the pattern is associated with a streaming of text, a music soundtrack, an absence of speech, an absence object movement, or an absence of an appearance of objects included in the body of the media item.

In another non-limiting embodiment, a method is provided comprising employing at least one processor executing computer executable instructions embodied on at least one non-transitory computer readable medium to facilitate performing operations comprising: analyzing a media item, identifying a transition point in the media item where end credits begin based on the analyzing, and presenting a prompt as a function of the identifying the transition point. The method can further comprise monitoring at least one of content or audio of the media item, wherein the analyzing the media item includes analyzing the at least one of the content or the audio and identifying a pattern of the media item associated with the end credits, and wherein the identifying the transition point includes identifying the transition point as a function of the pattern. In various aspects, the pattern is associated with a streaming of text, a music soundtrack, an absence of speech, an absence object movement, or an absence of an appearance of objects included in the body of the media item.

Further provided is a computer-readable storage medium comprising computer-readable instructions that, in response to execution, cause a computing system to perform operations, comprising: analyzing a media item, identifying a transition point in the media item where end credits begin based on the analyzing, and presenting a prompt as a function of the identifying the transition point. In an aspect, the operations further comprise monitoring at least one of content or audio of the media item, wherein the analyzing the media item includes analyzing the at least one of the content or the audio and identifying a pattern of the media item associated with the end credits, and wherein the identifying the transition point includes identifying the transition point as a function of the pattern.

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level functional block diagram of an example system for facilitating automatically identifying end credits in a media item;

FIG. 2 illustrates another high-level functional block diagram of an example system for facilitating automatically identifying end credits in a media item;

FIG. 3 presents an exemplary representation of an end credits frame in a media item;

FIG. 4 illustrates a method for presenting prompts during the playing of media item at a transition point where end credits begin;

FIG. 5 illustrates another method for presenting prompts during the playing of media item at a transition point where end credits begin;

FIG. 6 illustrates another method for presenting prompts during the playing of media item at a transition point where end credits begin;

FIG. 7 illustrates various basis's for identifying a pattern in a media item via an analysis component; and

FIG. 8 illustrates a block diagram representing exemplary non-limiting networked environments in which various non-limiting embodiments described herein can be implemented.

FIG. 9 illustrates a block diagram representing an exemplary non-limiting computing system or operating environment in which one or more aspects of various non-limiting embodiments described herein can be implemented.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

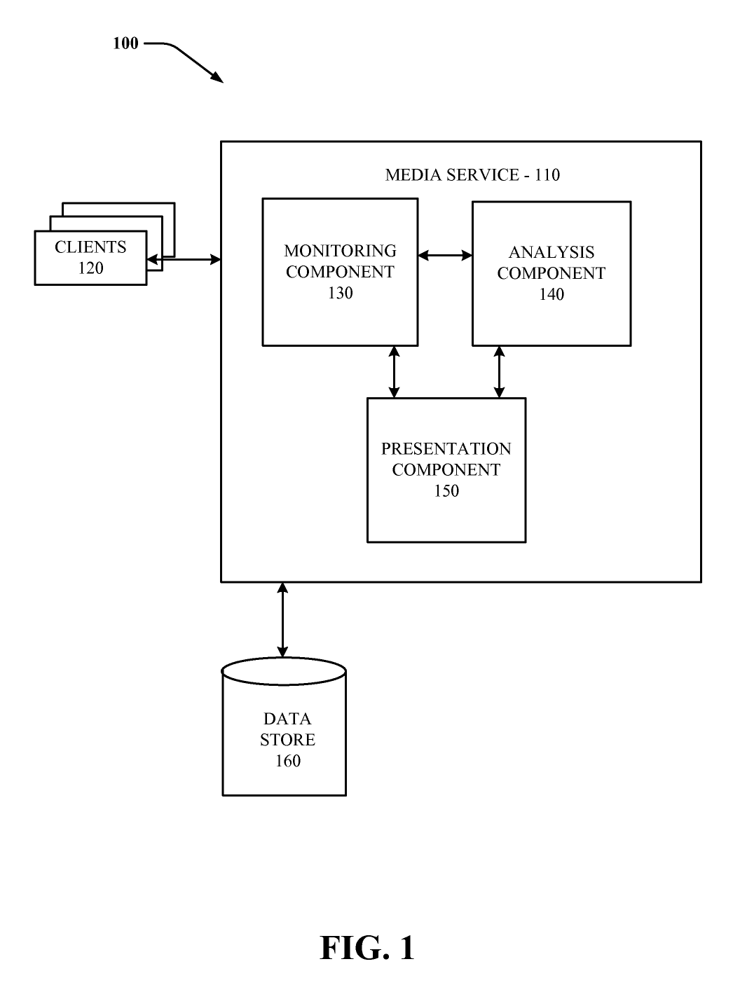

Referring now to the drawings, with reference initially to FIG. 1, a system 100 than can facilitate automatically identifying end credits in a media item is presented. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory (not depicted) for storing computer executable components and instructions. A processor (not depicted) can facilitate operation of the computer executable components and instructions by the system 100.

In an embodiment, system 100 includes one or more clients 120 and a media service 110. Client 120 can include any computing device generally associated with a user and capable of playing a media item and interacting with media service 110. For example, a client 120 can include a desktop computer, a laptop computer, an interactive television, a smartphone, a gaming device, or a tablet personal computer (PC). As used herein, the term user refers to a person, entity, or system that uses a client device 120 and/or employs media service 110. In particular, as discussed infra a client device 120 is configured to employ media service 110 to receive prompts associated with a media item. As used herein, the term “media item” is intended to relate to an electronic visual media product and includes video, television, streaming video and so forth. For example, a media item can include a movie, a video game, a live television program, or a recorded television program. In one embodiment, a client 120 is configured to access media service 110 via a network such as the Internet or an intranet. In another embodiment, media service 110 is integral to a client. For example, although client 120 and media service 110 are depicted separately in FIG. 1, in an aspect, client 120 can include media service 120.

In an aspect, a client computer 120 interfaces with media service 110 via an interactive web page. For example a page, such as a hypertext mark-up language (HTML) page, can be displayed at a client device and is programmed to be responsive to a the playing of a media item at the client device 120. It is noted that although the embodiments and examples will be illustrated with respect to an architecture employing HTML pages and the World Wide Web, the embodiments and examples may be practiced or otherwise implemented with any network architecture utilizing clients and servers, and with distributed architectures, such as but not limited to peer to peer systems.

In an embodiment, media service 110 is configured to monitor the playing of a media item on a client 120 in order to identify a transition point in the media item where end/closing credits begin. As used herein, closing/end credits include credits at the end of a media item, (i.e. a motion picture, television program, or video game) which list the cast and crew involved in the production of the media item. The media service 110 is further configured to act upon the identification of the transition point in a variety of ways. For example, in an aspect, the media service 110 is configured to present a prompt which can include but is not limited to, a survey to rate the media item, an advertisement, or a link to content associated with the media item.

In an embodiment, the media service 110 can include an entity such as a world wide web, or Internet, website configured to provide media items. According to his embodiment, a user can employ a client device 120 to view or play a media item as it is streaming from the cloud over a network from the media service 110. For example, media service 110 can include a streaming media provider such as YouTube™, Netflix™, or a website affiliated with a broadcasting network. In another embodiment, media service 110 can be affiliated with a media provider, such as an Internet media provider or a television broadcasting network. According to this embodiment, the media provider can provide media items to a client 120 and employ media service 110 to monitor the media items and present prompts to the client 120 associated with the media items. Still in yet another embodiment, a client device 120 can include media service 110 to monitor media items received from external sources or stored and played locally at the client device 120.

Referring back to FIG. 1, in order to facilitate identifying initiation of end credits of a media item and to facilitate providing prompts associated with the identifying, media service 110 can include a monitoring component 130, analysis component 130, a monitoring component 140, and a presentation component 150. In an aspect, monitoring component 130 is configured to monitor at least one of content or audio of a media item, and analysis component 140 is configured to analyze the media item, and identify a transition point in the media item where end credits begin. The presentation component 150 is configured to present a prompt based on the transition point.

In an aspect, monitoring component 130 is configured to monitor content and/or audio of a media item and present the monitored content to analysis component for analysis. In particular, the monitoring component 130 is configured to monitor content and/or audio of a media item as the media item is playing on a client 120. In an aspect, the monitoring component 130 is configured to monitor content and/or audio of a media item in real time or substantially real time. In other words, the monitoring component 130 can monitor content and/or audio of a media item in substantially real time as it is appearing when played on a client device 120.

Regarding content of a media item, in an aspect, monitoring component 130 is configured to monitor objects in the media item including characteristics of the objects and object movement. Objects in a media item can include but are not limited to, people, animals, and items of manufacture. In addition, objects can include natural objects such as those affiliated with scenery, including trees, sky, bodies of water, and etc. Further, objects can include animated objects. Characteristics of the objects can include but are not limited to size, shape, facial expressions and features, clothing, coloring and etc. Object movement can include the manner of movement, direction, acceleration and speed. Further, the monitoring component 130 can monitor general characteristics of a media item including image color, image quality, and characteristics associated with camera techniques. For example, the monitoring component can monitor contrast, brightness, color dispersion, zoom in's, fade outs, and etc. In addition, the monitoring component is configured to monitor text present in a media item, including the type of text, the size of the text, the movement of the text, the configuration of the text, and the layout of the text.

With regards to audio, the monitoring component 130 is configured to monitor speech, music, and non-speech or music type noises. In an aspect, the monitoring component 130 is configured to monitor objects and noises associated with the objects, including speech and other noises. In an example, the monitoring component can monitor the movement of a door slamming and the associated slamming noise. The monitoring component can further monitor background noise and background music.

Analysis component 140 is configured to analyze monitored content and/or audio of a media item in order to determine a transition point in the media item where end credits begin. In an aspect, the analysis component 140 is configured to analyze a media item in order to identify a pattern in the media item which indicates an end credits transition point in the media item. Further, the analysis component 140 is configured to perform analysis of a media item in real-time or near real-time. For example, the analysis component 140 is configured to identify a pattern in a media item as the media item is playing on a client 120 and as the content and/or audio of the media item is monitored in real-time or near real-time by the monitoring component 130.

In an embodiment, a pattern can be predefined as pattern which indicates end credits. According to this embodiment, data store 160 can include a look-up table with a plurality of pre-defined patterns. Each of the pre-defined patterns can indicate that the end credits of the media item have begun. Therefore, in an aspect the analysis component is configured to identify a pattern in a media item that is pre-defined in data store 160 as signaling end credits in order to determine that the end credits have begun. It should be appreciated that although data store 160 is depicted as external from media service 110, data store 160 can be internal to media service 110. In an aspect data store 160 can be centralized, either remotely or locally cached, or distributed, potentially across multiple devices and/or schemas. Furthermore, data store 160 can be embodied as substantially any type of memory, including but not limited to volatile or non-volatile, solid state, sequential access, structured access, random access and so on.

In an aspect, a pattern can be associated with any one or more of the following: a streaming of text, a music soundtrack, an absence of speech, an absence of object movement, or an absence of objects included in the body of the media item. In another aspect, a pattern can be associated with identification of any of the above features for a predefined amount of time. For example, a predefined amount of time can include one second, three seconds, five seconds, ten seconds, and etc. According to this aspect, a pattern can include any one or more of the following for a predefined amount of time: a streaming of text, a music soundtrack, an absence of speech, an absence of object movement, or an absence of objects included in the body of the media item.

A pattern can range in complexity. In general, end credits usually appear as a list of names in small type, which either flip very quickly from page to page, or move smoothly across the background or a black screen. End credits may crawl either right-to-left, top-to-bottom or bottom-to-top. Accordingly, a simple pattern can include the appearance of streaming text, or the appearance of background music. A more complex pattern could include the combination of the appearance of streaming text from top-to-bottom for at least three seconds, background music, and a blank screen containing an absence of object movement. Still another pattern could include a transition-type pattern marked by a transition from a media frame comprising first characteristics to a media frame comprising second characteristics. For example, a pattern could include a fade out from a scene in the media item containing speech and people to a scene with a still background and no speech or people yet background music. In another aspect, a pattern can be associated with a the appearance of a single word or a combination of words. For example, a pattern could include the appearance of the word “cast,” “crew,” “director” or “producer.” In another example, a pattern could include the appearance of the phrase “the end,” or the appearance of two first and last names followed by one another.

In an embodiment, in order to identify a pattern in a media item, the analysis component 140 can employ visual media analysis software configured to analyze content and/or audio of a media item. For example, the analysis component 140 can employ video analysis software to determine movement of objects, characteristics of object, the identity of objects, changes in dimensions of objects (such as changes in dimensions associated with close ups and fade outs), the colors present in different frames of a media item, the text written in a media item, the words spoken and inflection in the words spoken in a media item, sounds, instruments, characteristics of music. Based on any of the above identified elements, the analysis component 140 is configured to identify a pattern in the media item. The analysis component 140 can further compare an identified pattern to the pattern's stored in data store 160 do determine whether an identified pattern is indicative of end credits.

In an example, video motion analysis software can include DataPoint™, and “ProAnalyst 3-D Flight Path Edition™. Motion analysis includes methods and applications in which two or more consecutive images from an image sequences, e.g., produced by a video camera, are processed to produce information based on the apparent motion in the images. In some applications, the camera is fixed relative to the scene and objects are moving around in the scene, in some applications the scene is more or less fixed and the camera is moving, and in some cases both the camera and the scene are moving.

Motion analysis processing can in the simplest case be to detect motion, i.e., find the points in the image where something is moving. More complex types of processing can be to track a specific object in the image and over time, to group points that belong to the same rigid object that is moving in the scene, or to determine the magnitude and direction of the motion of every point in the image. The information that is produced is often related to a specific image in the sequence, corresponding to a specific time-point, but then depends also on the neighboring images. This means that motion analysis can produce time time-dependent information about motion

Presentation component 150 is configured to present a client 120 with a prompt in response to the analysis component 140 identifying a transition point in a media item where end credits begin. For example, the presentation component 150 is configured to present a prompt to a client device 120 while the client device 120 is playing the media in which an end credits transition point has been identified. In an aspect, the presentation component 150 is configured to present a client 120 with a prompt in response to the analysis component 140 identifying a pattern in a media item which is indicative of a transition point to end credits. For example, the prompt can be in the form of and interactive pop-up message. In an embodiment, the prompt can include a survey about the media item. For example, as a user is viewing a media item such as a movie on his or her client device 120 the user could receive a pop-up dialogue box in on his or her device screen with a prompt to complete a survey about the media item. According to this example, the survey could ask a user to rate the media item or write a review of the media item. In another embodiment, the prompt could include an advertisement. For example, the prompt could include a commercial or a pictorial advertisement. Still in yet another embodiment, the prompt could include a link to content associated with the media item. For example, the prompt could include a link to similar media items, trailers for similar media items, extra scenes associated with the media item, or merchandise affiliated with the media item.

In an embodiment, prompts to be presented by presentation component 150 can be stored in data store 160. For example, data store 160 can store surveys for media items, advertisements for media items, and prompts to content associated with the media items. In another aspect, prompts for media items can be stored in another data store that can be accessed by presentation component 150.

In an aspect, the presentation component 150 can employ information in data store 160 in order to determine the prompt to present to a client 120 in response to an end credits transition point. In particular, data store 160 can include rules defining the type of prompt to present to a client device 120 and parameters associated with presenting the prompt. For example, the data store 160 can include a rule which requires the presentation component 150 to present a survey to a client 120 in response to an identified transition point to end credits. Rules can further include parameters associated with presenting the prompt, such as timing requirements and/or display requirements.

In another aspect, the data store 160 can include information defining specific rules for prompts based on the media item. According to this aspect, the type of prompt to present to client device 120 can depend on the media item. For example, the media item may be associated with a prompt for one or more of a survey, an advertisement or a prompt for a link to content associated with the media item. According to this example, the presentation component 150 can look up the media item that is being played on a client device 120 and identify a prompt to present based on the media item. Further, in an aspect, the presentation component 150 may present multiple prompts to a client device 120 in response to the identification of a transition point to end credits. For example, when a media item is associated with multiple prompts, the presentation component can present the multiple prompts. According to this example, in response to end credits appearing in a media item, the client device 120 playing the media item may be presented with an advertisement and a survey.

In an embodiment, the presentation component 150 is further configured to present a prompt in a timed delayed manner upon the recognition of a transition point to end credits by the analysis component. According to this aspect, the presentation component 150 can present a prompt after a pre-determined amount of time has passed following the identification of the end credits transition point. For example, the presentation component 150 can present a prompt three seconds, five seconds, ten seconds, thirty seconds, and etc. following the identification of a transition point to end credits. Accordingly, the presentation component 150 can allow a user of a client device 120 to view at least a portion of the end credits prior to being disrupted with a prompt.

In another aspect, the presentation component 150 is configured to present a prompt as a function of the language of the media item. According to this aspect, the analysis component 140 is configured to analyze speech audio and/or text appearing in a media item in order to identify a language of the media item. For example, the analysis component 140 is configured to determine whether a media item is in English, Spanish, French, and etc. As a result, the presentation component 150 is configured to present a prompt in the language of the media item. For example, when the analysis component 140 identifies that a media item is presented in English, the presentation component can present a prompt in English.

Still in yet another embodiment, the presentation component 150 is configured to present a prompt at a client device 120 as a function of the display requirements of the client device and/or the configuration or layout of the end credits. In an aspect, the analysis component 140 is configured to determine the display requirements of a client device 120, such as screen size and configuration. In addition, in an aspect, the analysis component 140 can determine the layout and/or configuration of the end credits of a media item. For example, the analysis component 140 is configured to determine the size and orientation of text associated with end credits. In another example, the analysis component 140 is configured to determine areas of an image frame that do not include text associated with end credits and the size in configuration of those areas. In turn the presentation component 150 is configured to present a prompt with a size, shape, and/or orientation, which fits the display requirement of a client device and accommodates the size, shape, and/or configuration of the end credits text. For example, the presentation component 150 can display a prompt in an area associated with blank space of the end credits or in an area that does not contain text.

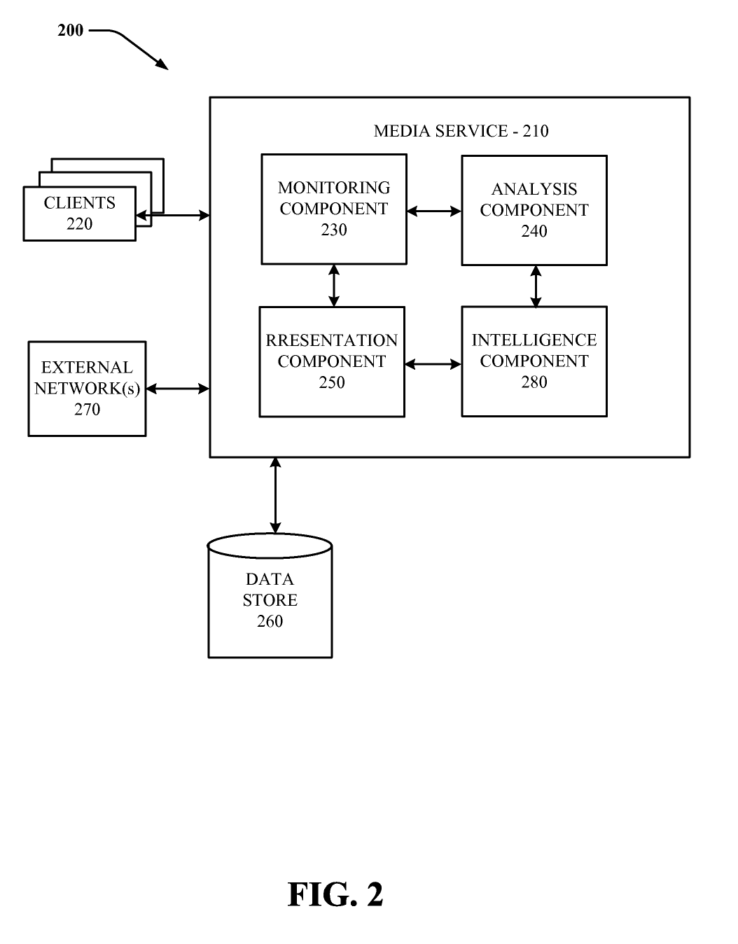

Turning now to FIG. 2, a system 200 configured to facilitate automatically identifying a transition point to end credits in a media item and providing a prompt in response in accordance with an embodiment of the subject disclosure. Similar to system 100, system 200 includes one or more clients 220, media service 210, and data store 260. Also similar to system 100, system 200 includes a monitoring component 230, an analysis component, 240 and a presentation component 250. It should also be appreciated that clients 220, media service 210, data store 260, monitoring component 230, analysis component, 240 and presentation component 250 and can include at least the features of clients 120, media service 110, data store 160, monitoring component 130, analysis component, 140 and presentation component 150 discussed supra with respect to system 100. In addition, system 200 can include external networks 270 and media service 210 can include an intelligence component.

In an embodiment, as discussed supra, the analysis component 240 can employ video analysis software to identify patterns in a media item. For example, the video analysis software can identify the identity of objects in a video, the movement of objects in a video, the actions of objects or people in a video, the scenery of a video and etc. In another example, the video analysis software can analyze speech in a video including words spoken, the tone of the words spoken, the language of the words spoken, the dialect of the words spoken, the intonation of the words spoken and etc. in order to facilitate determining what a video is about or the content of a video. Similarly, the video analysis software can employ other audio sounds in a video such as waves crashing, cars moving, footsteps, birds chirping, police sirens, and etc. in order to facilitate determining patterns in the video.

The analysis component 240 can further employ a look-up table in data store 260 to determine whether an identified pattern signals an end credits transition point. In another embodiment, in order in order to determine a transition point in a media item, the analysis component 240 can employ video analysis software to analyze monitored content and/or audio of a media item to identify features of the media item. The analysis component 240 can further employ intelligence component 280 to infer features of the media item based on the monitored content and/or audio. Features can include any of the above identified aspects of patterns. For example, features of a media item can include but are not limited to: a streaming of text, a music soundtrack, an absence of speech, a absence of object movement, or an absence of objects included in the body of the media item. Features of a media item can further include additional information, such as specific scenes, actions of characters, dialogue of characters, scene development, or timing of a media item. For example, the monitoring component is configured to monitor the time of a media item. In an aspect, the analysis component 240 can further determine the length of time of a media item.

According to this embodiment, in order to identify a transition point in a media item, the analysis component 240 can employ an intelligence component 280 to infer the transition point. Intelligence component 280 can provide for or aid in various inferences or determinations. For example, all or portions of monitoring component 230, analysis component 240, presentation component 250, and media service 210 (as well as other components described herein with respect to systems 100 and 200) can be operatively coupled to intelligence component 280. Additionally or alternatively, all or portions of intelligence component 280 can be included in one or more components described herein. Moreover, intelligence component 280 may be granted access to all or portions of media items, and external networks 270 described herein.

In order to provide for or aid in the numerous inferences described herein (e.g., inferring characteristics of media items and inferring end credit transition points), intelligence component 280 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority. Any of the foregoing inferences can potentially be based upon, e.g., Bayesian probabilities or confidence measures or based upon machine learning techniques related to historical analysis, feedback, and/or other determinations or inferences.

In an aspect, intelligence component 280 is configured to infer a transition point to end credits in a media item based on identified or inferred characteristics of the media item. According to this aspect, for example, the intelligence component is configured to infer that streaming text against stagnant background screen indicates a transition point to end credits. In an embodiment, data store 260 can further store information associating media item features with probabilities associated with end credit transition points. For example, a feature such a music soundtrack can be associated with end credits and weighted with a medium probability that the presence of a soundtrack signals end credits. On the contrary, a feature such as a chasing scene could be given a low probability as being associated with end credits.

Further, combined features can attribute greater confidence levels for accurate end credit transition point identification. For example, the intelligence component 280 can infer that the feature of a soundtrack signifies a 60% probability that end credits have begun. However, the intelligence component 280 my further infer to a greater confidence level that the presence of a soundtrack and no object movement signifies a 70% probability that end credits have begun. Still further, the intelligence component may infer that the presence of a soundtrack, no object movement, and only 6 minutes left of movie time, the probability that the end credits have begun is 90%, and so on. In an aspect, the presentation component 250 can further be restricted in presenting a prompt until a desired confidence interval is reached. For example, the presentation component can present a prompt when a confidence level of 90% is reached, which indicates that there is a 90% probability that the end credits have begun.

In an embodiment, it is possible that at times the intelligence component 280 makes an inaccurate determination as to when end credits begin. For example, in an aspect, a prompt can include a question whether “the media item is over or finished” and allow a user to select a command box indicating “yes” or “no.” According to this embodiment, each time a user selects “yes,” the intelligence component 280 can log the features employed in the determination of the end credits inn data store 280 to learn from the features employed for future inferences and determinations. In an aspect, the intelligence component 280 can log the features employed to make the end credits determination with an identification of the media item. For example, the intelligence component 280 can indicate in data store 260 that for movie XYZ, the features, ABC signify the end credits transition point. Further, when the intelligence component 280 is required to identify the end credits transition point for the same media item on another occasion, the intelligence component 280 can merely employ its previous determinations. Similarly, where a user selects “no,” the intelligence component 280 can log the features employed in the determination of the end credits in data store 280 to learn from the features employed for future inferences and determinations.

Referring back now to FIG. 2, once the analysis 240 and/or intelligence components 280 identifies or infers a transition point to end credits in a media item, the presentation component 250 is configured to present a prompt. In an aspect, discussed infra, the presentation component can identify an appropriate prompt to present based on information in data store 260. In another aspect, presentation component can employ intelligence component 280 and infer a prompt to present to a client device. According to this aspect, the intelligence component can employ additional information about the context of the client device, information about the user of the client device, the location of the client device, and/or social and current media to facilitate selecting a prompt to present to a client device. For example, the intelligence component may infer that based on user preferences, a prompt comprising a link to similar content of the media item should only include movies produced in the last five years. In another example, the intelligence component may infer that because of the demographics of the user associated with a client device, a prompt should include a link to purchase the “female” related items. In another aspect, based on the user's location and time of watching the media item, the prompt should include an advertisement to fast food areas open and within a five mile radius of the user's location. According to an embodiment, in order to facilitate making inferences regarding prompts, the intelligence component 280 can employ one or more external networks 270.

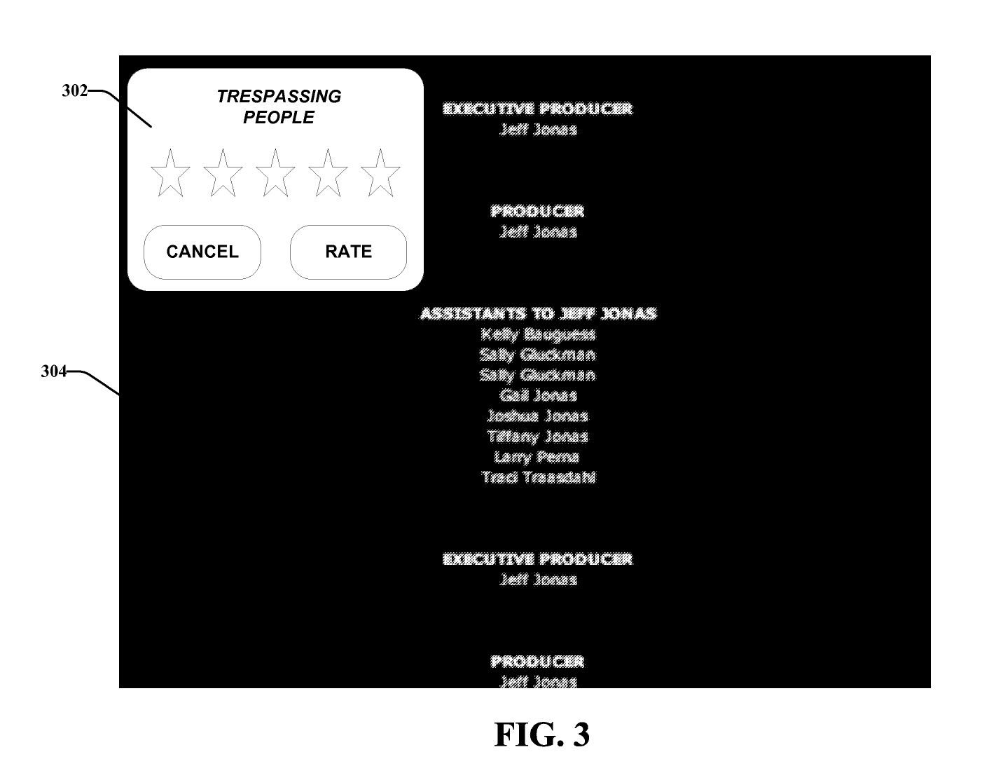

Referring now to FIG. 3 presented is an exemplary representation of an end credits frame 304 in a media item. In an aspect, the end credits frames are being displayed on a client device such as a laptop computer via a media player. Further, it can be assumed that the media item is a movie entitled “Trespassing People.” In an aspect, in order to view the movie, a client device can access the video from an external network. In another aspect, the external network can include or employ a media service 110/120. As seen in FIG. 3, a prompt 302 which is a survey about the movie is being displayed in the upper left hand corner of the media item frame containing the end credits 304. In an aspect, the survey allows a view of the media item to rate the movie by selecting an appropriate amount of stars. In an example, in order to have identified the end credits transition point presented in FIG. 3, the analysis or intelligence component may have identified features such as a blank screen, streaming text, background music, the words “executive producer,” or “producer,” or a combination of any of the above features. In addition, as seen in FIG. 3, the survey prompt does not infringe on the text associated with the end credits. It can be appreciated that the presentation component identified the dimensions of the blank space (area of the screen not comprising text) and provided the prompt 302 with a size and shape to fit in the blank space.

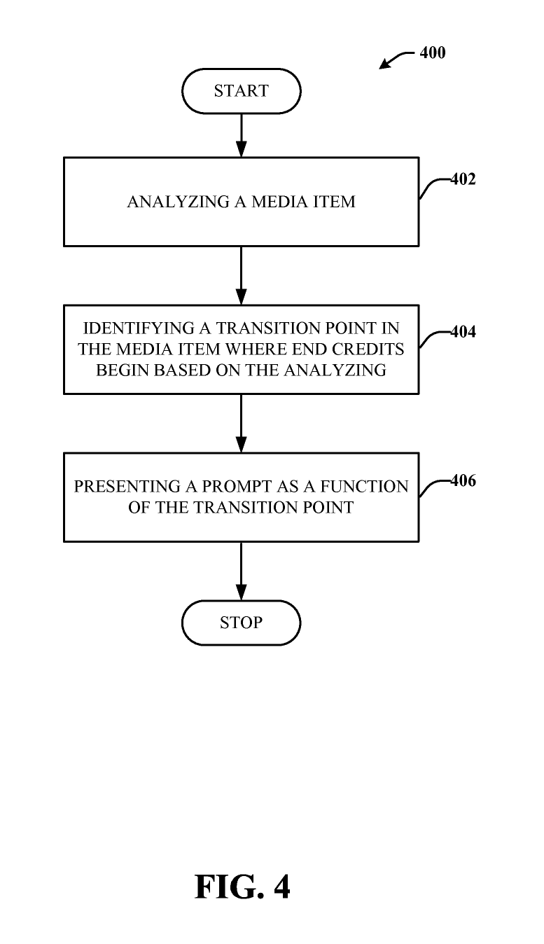

FIGS. 4-7 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers.

Referring now to FIG. 4, presented is an exemplary non-limiting embodiment of a method 400 for presenting prompts during the playing of media item at a transition point where end credits begin. Generally, at reference numeral 402, a media item is analyzed. For example, a media item can be analyzed by an analysis component or an intelligence component of a media service. In an aspect, the media item is analyzed in real-time or near real-time as the media item is playing on a client device. At 402, a transition point in the media item where end credits begin is identified based on the analyzing. Then, at 406, a prompt is presented as a function of the transition point.

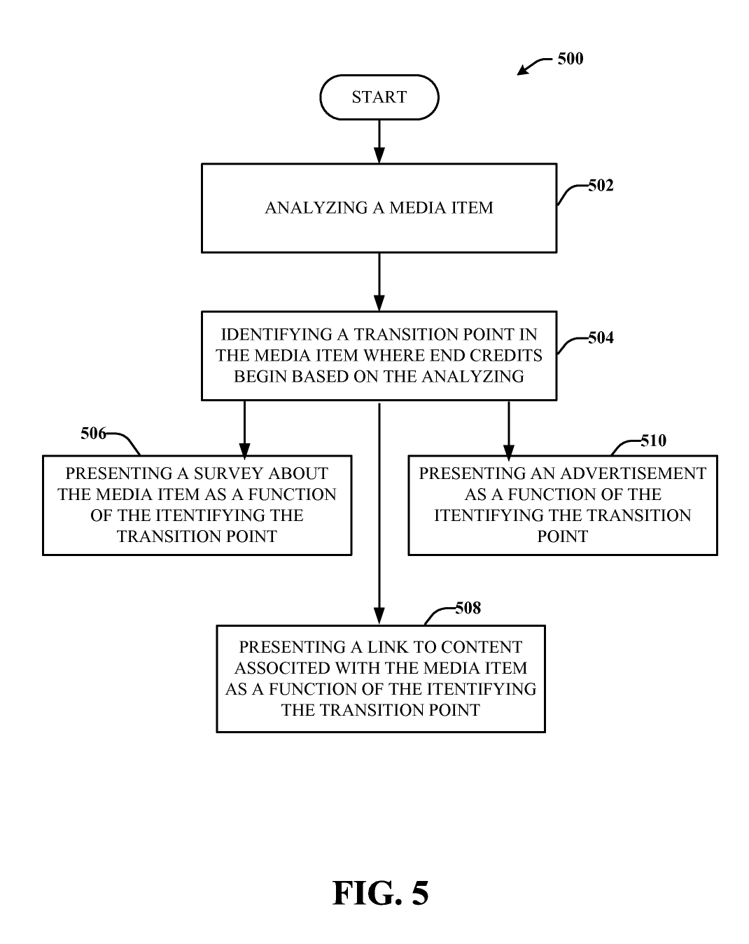

FIG. 5 presents another exemplary non-limiting embodiment of a method 500 for presenting prompts during the playing of media item at a transition point where end credits begin. Generally, at reference numeral 502, a media item is analyzed. For example, a media item can be analyzed by an analysis component or an intelligence component of a media service. In an aspect, the media item is analyzed in real-time or near real-time as the media item is playing on a client device. At 502, a transition point in the media item where end credits begin is identified based on the analyzing. Then, at 506, in one aspect, a survey about the media item is presented as a function of the identify the transition point. At 508, in another aspect, a link to content associated with the media item is presented as a function of the identifying the transition point. Still in yet another aspect, at 520, an advertisement is presented as a function of the identifying the transition point. In an aspect, the prompts presented at 506-510 can be presented after the passing of a predetermined amount of time after the identifying the transition point. For example, the presentation component can present the survey at 506 fifteen seconds after the identifying the transition point.

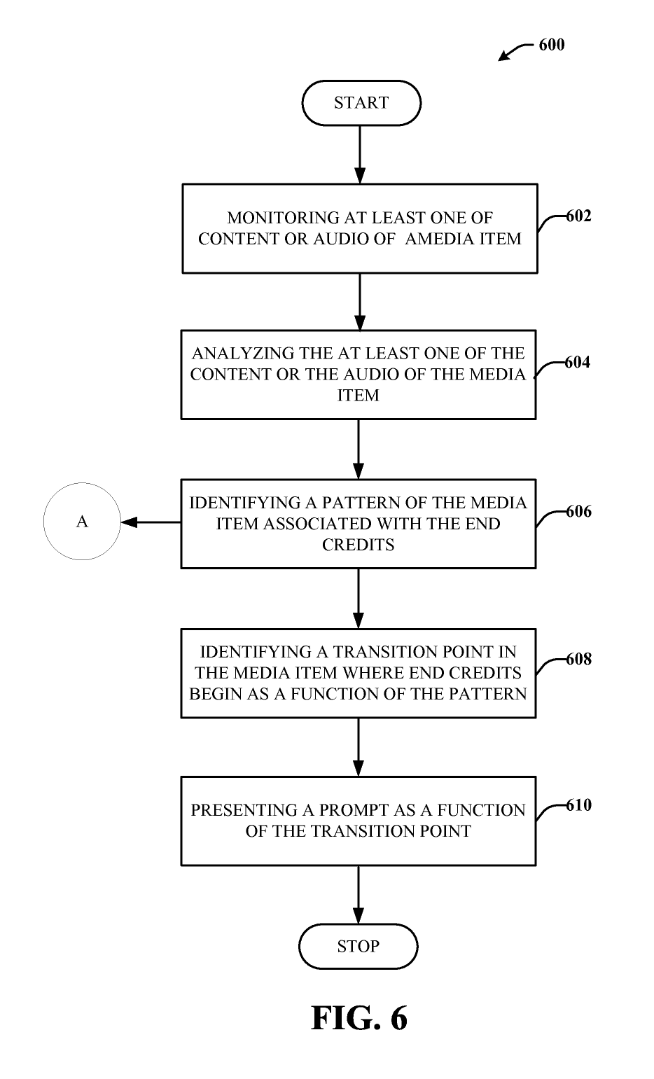

FIG. 6 presents another exemplary non-limiting embodiment of a method 600 for presenting prompts during the playing of media item at a transition point where end credits begin. Generally at 602, at least one of the content or audio of a media item is monitored. Then at 604, the at least one of the content or the audio of the media item is analyzed. At 606 a pattern of the media item associated with the end credits is identified. For example, an analysis component can employ a look-up table in a data store that pre-associates specific patterns with end credits. In another example, an intelligence component can infer the an end credits transition point based on the content and/or audio. At 608, a transition point in the media item where end credits begin is identified as a function of the pattern. Then at 610, a prompt is presented as a function of the transition point.

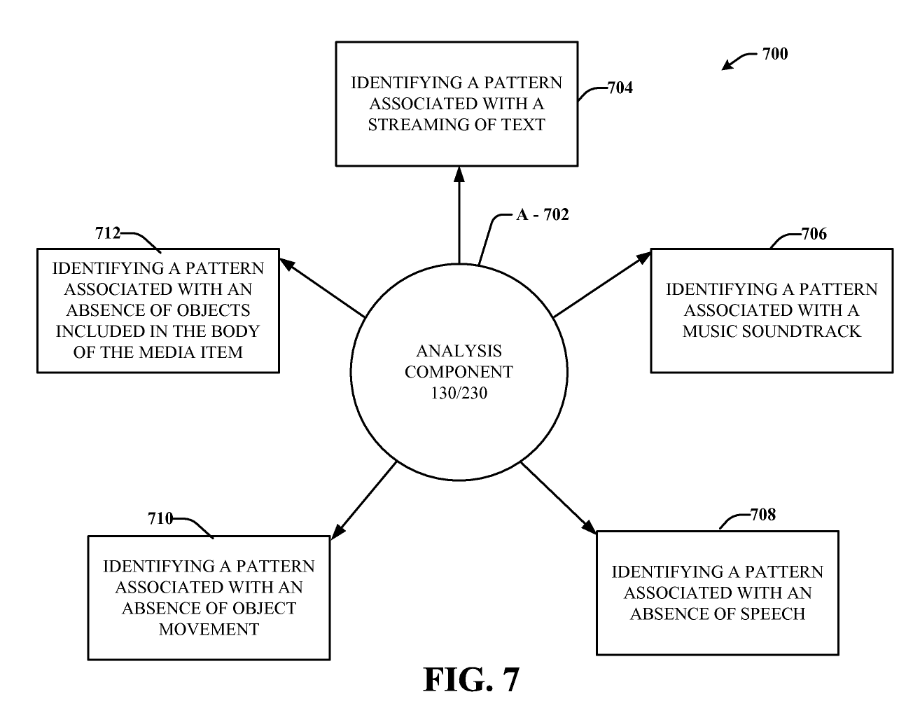

FIG. 7 presents various basis's 700 for identifying a pattern in a media item via an analysis component 130/230 at point A in step 606 of method 600. Generally, at reference numeral 702, the media item can be analyzed by analysis component 130/230. In particular, an analysis component 130/230 can perform identification of a pattern associated with at least one of: a streaming of text 704, a music soundtrack 706, an absence of speech 708, an absence of object movement 710, or an absence of objects included in the body of the media item 712. In an aspect, analysis component 130/230 can perform identification of a patter associated with any of 704-712 as a function of a duration time associated with each of the features included in 704-712. For example, the analysis component 130/230 can perform identification of a pattern associated with a streaming of text for at least five seconds.

### Example Operating Environments

FIG. 7 One of ordinary skill in the art can appreciate that the various non-limiting embodiments of end credit identification and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

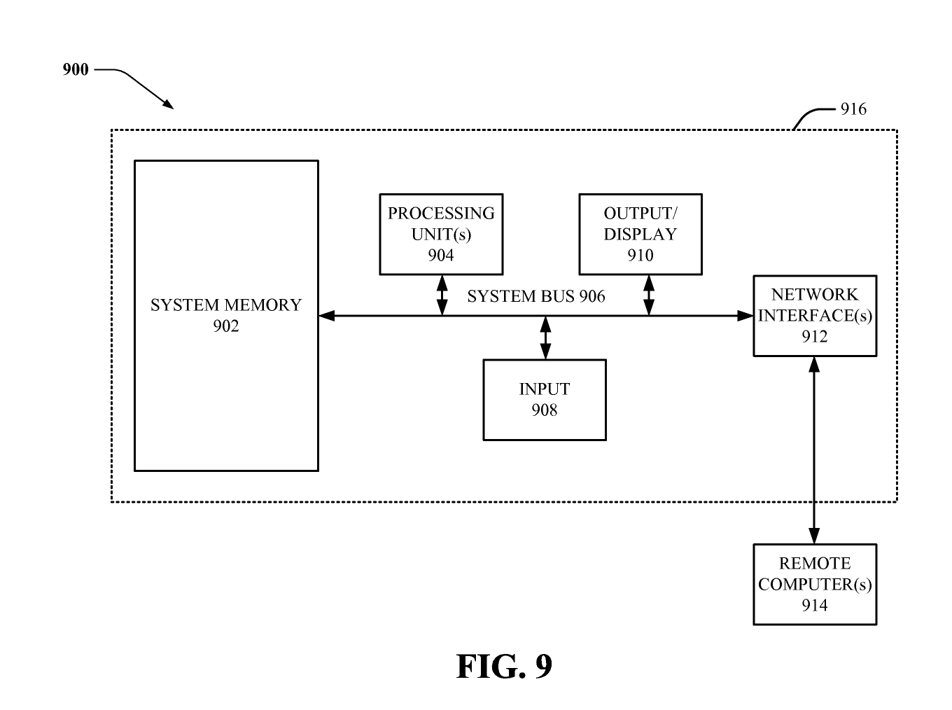

FIG. 9 provides a schematic diagram of an exemplary networked or distributed computing environment. The distributed computing environment comprises computing objects 822, 816, etc. and computing objects or devices 802, 806, 810, 826, 814, etc., which may include programs, methods, data stores, programmable logic, etc., as represented by applications 804, 808, 812, 824, 820. It can be appreciated that computing objects 822, 816, etc. and computing objects or devices 802, 806, 810, 826, 814, etc. may comprise different devices, such as personal digital assistants (PDAs), audio/video devices, mobile phones, MP3 players, personal computers, laptops, etc.

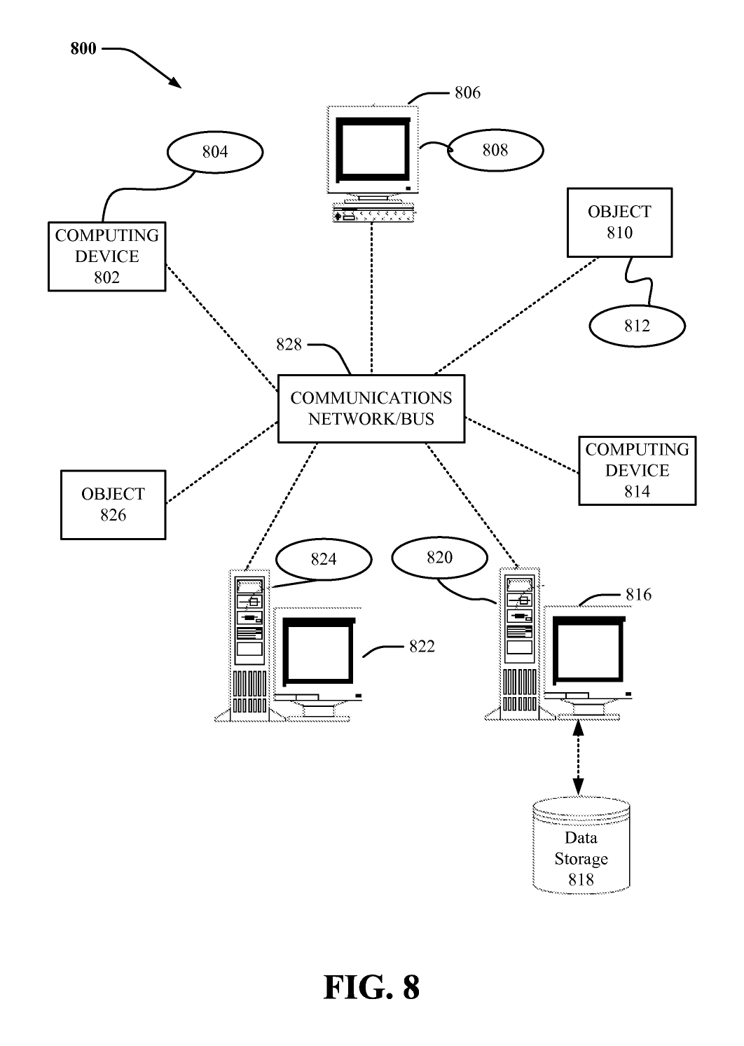

Each computing object 822, 816, etc. and computing objects or devices 802, 806, 810, 826, 814, etc. can communicate with one or more other computing objects 822, 816, etc. and computing objects or devices 802, 806, 810, 826, 814, etc. by way of the communications network 826, either directly or indirectly. Even though illustrated as a single element in FIG. 8, communications network 826 may comprise other computing objects and computing devices that provide services to the system of FIG. 8, and/or may represent multiple interconnected networks, which are not shown. Each computing object 822, 816, etc. or computing object or device 802, 806, 810, 826, 814, etc. can also contain an application, such as applications 804, 808, 812, 824, 820, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 8, as a non-limiting example, computing objects or devices 802, 806, 810, 826, 814, etc. can be thought of as clients and computing objects 822, 816, etc. can be thought of as servers where computing objects 822, 816, etc., acting as servers provide data services, such as receiving data from client computing objects or devices 802, 806, 810, 826, 814, etc., storing of data, processing of data, transmitting data to client computing objects or devices 802, 806, 810, 826, 814, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 826 or bus is the Internet, for example, the computing objects 822, 816, etc. can be Web servers with which other computing objects or devices 802, 806, 810, 826, 814, etc. communicate via any of a number of known protocols, such as the hypertext transfer protocol (HTTP). Computing objects 822, 816, etc. acting as servers may also serve as clients, e.g., computing objects or devices 802, 806, 810, 826, 814, etc., as may be characteristic of a distributed computing environment.

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 26 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 26 thus illustrates an example of a suitable computing system environment 900 in which one or aspects of the non-limiting embodiments described herein can be implemented, although as made clear above, the computing system environment 900 is only one example of a suitable computing environment and is not intended to suggest any limitation as to scope of use or functionality. Neither should the computing system environment 900 be interpreted as having any dependency or requirement relating to any one or combination of components illustrated in the exemplary computing system environment 900.

With reference to FIG. 9, an exemplary remote device for implementing one or more non-limiting embodiments includes a general purpose computing device in the form of a computer 916. Components of computer 916 may include, but are not limited to, a processing unit 904, a system memory 902, and a system bus 906 that couples various system components including the system memory to the processing unit 904.

Computer 916 typically includes a variety of computer readable media and can be any available media that can be accessed by computer 916. The system memory 902 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 902 may also include an operating system, application programs, other program modules, and program data.

A user can enter commands and information into the computer 916 through input devices 908. A monitor or other type of display device is also connected to the system bus 906 via an interface, such as output interface 912. In addition to a monitor, computers can also include other peripheral output devices such as speakers and a printer, which may be connected through output interface 912.

The computer 916 may operate in a networked or distributed environment using logical connections to one or more other remote computers, such as remote computer 912. The remote computer 912 may be a personal computer, a server, a router, a network PC, a peer device or other common network node, or any other remote media consumption or transmission device, and may include any or all of the elements described above relative to the computer 916. The logical connections depicted in FIG. 9 include a network, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described infra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory having computer executable components stored thereon; and
a processor communicatively coupled to the memory, the processor configured to facilitate execution of the computer executable components, the computer executable components, comprising:
an analysis component configured to analyze a media item and identify a transition point in the media item where end credits begin; and
a presentation component configured to present a prompt based on the transition point.

2. The system of claim 1, wherein the prompt includes a survey about the media item.

3. The system of claim 1, wherein the prompt includes an advertisement.

4. The system of claim 1, wherein the prompt includes a link to content associated with the media item.

5. The system of claim 1, wherein the presentation component is configured to present the prompt after a predetermined amount of time following the identification of the transition point.

6. The system of claim 1, further comprising:
a monitoring component configured to monitor at least one of content or audio of the media item, wherein the analysis component is configured to analyze the at least one of the content or the audio and identify a pattern of the media item associated with the end credits, and wherein the analysis component is configured to identify the transition point as a function of the pattern.

7. The system of claim 6, wherein the pattern is associated with a streaming of text.

8. The system of claim 6, wherein the pattern is associated with a music soundtrack.

9. The system of claim 6, wherein the pattern is associated with an absence of speech.

10. The system of claim 6, wherein the pattern is associated with an absence object movement.

11. The system of claim 6, wherein the pattern is associated with an absence of an appearance of objects included in the body of the media item.

12. The system of claim 6, wherein the pattern includes, for a predetermined duration of time, at least one of: a streaming of text, a music soundtrack, an absence of speech, an absence of object movement, or an absence of an appearance of objects included in the body of the media item.

13. A method, comprising:
employing at least one processor executing computer executable instructions embodied on at least one non-transitory computer readable medium to to facilitate performing operations comprising:
analyzing a media item;
identifying a transition point in the media item where end credits begin based on the analyzing; and
presenting a prompt as a function of the identifying the transition point.

14. The method of claim 13, wherein the presenting the prompt includes presenting a survey about the media item.

15. The method of claim 13, wherein the wherein the presenting the prompt includes presenting an advertisement.

16. The method of claim 13, wherein the wherein the presenting the prompt includes presenting a link to content associated with the media item.

17. The method of claim 13, wherein the wherein the presenting the prompt includes presenting the prompt after a predetermined amount of time following the identifying the transition point.

18. The method of claim 13, further comprising:
monitoring at least one of content or audio of the media item, wherein the analyzing the media item includes analyzing the at least one of the content or the audio and identifying a pattern of the media item associated with the end credits, and wherein the identifying the transition point includes identifying the transition point as a function of the pattern.

19. The method of claim 18, wherein the pattern is associated with a streaming of text.

20. The method of claim 18, wherein the pattern is associated with a music soundtrack.

21. The method of claim 18, wherein the pattern is associated with an absence of speech.

22. The method of claim 18, wherein the pattern is associated with an absence object movement.

23. The method of claim 18, wherein the pattern is associated with an absence of an appearance of objects included in the body of the media item.

24. The method of claim 18, wherein the pattern includes, for a predetermined duration of time, at least one of: a streaming of text, a music soundtrack, an absence of speech, an absence of object movement, or an absence of an appearance of objects included in the body of the media item.

25. A computer-readable storage medium comprising computer-readable instructions that, in response to execution, cause a computing system to perform operations, comprising:
analyzing a media item;
identifying a transition point in the media item where end credits begin based on the analyzing; and
presenting a prompt as a function of the identifying the transition point.

26. The computer-readable storage medium of claim 25, wherein the presenting the prompt includes presenting a survey about the media item.

27. The computer-readable storage medium of claim 25, wherein the wherein the presenting the prompt includes presenting the prompt after a predetermined amount of time following the identifying the transition point.

28. The computer-readable storage medium of claim 25, the operations further comprising:
monitoring at least one of content or audio of the media item, wherein the analyzing the media item includes analyzing the at least one of the content or the audio and identifying a pattern of the media item associated with the end credits, and wherein the identifying the transition point includes identifying the transition point as a function of the pattern.

29. The computer-readable storage medium of claim 28, wherein the pattern includes, for a predetermined duration of time, at least one of: a streaming of text, a music soundtrack, an absence of speech, an absence of object movement, or an absence of an appearance of objects included in the body of the media item.
